(19) United States
(12) Patent Application Publication
(10) Pub. No.: US 2011/0248059 A1
(43) Pub. Date: Oct. 13, 2011

(54) Holder for sunglasses or eyewear

(76) Inventors: Mark William Sowers, Prior Lake, MN (US); William Bruce Sowers, Prior Lake, MN (US)

(21) Appl. No.: 12/798,567

(22) Filed: Apr. 7, 2010

(51) Int. Cl. B60R 7/06

(52) U.S. Cl. 224/483

(57) ABSTRACT

The invention is a simple, safe, convenient sunglasses or eyewear holder to be used on the dash of a vehicle by the driver or passenger. In particular for the driver it is designed to reduce accidents resulting from driver distraction. The holder has no moving parts thus allowing the user the ability to use one hand to remove sunglasses or eyewear and place them with the temples still extended in the use position onto the holder and also to retrieve them with one hand and place them back on the user's face. The holder will be placed forward of the driver on the dash immediately to the right or left of the forward line of sight to the road. The holder includes the ability to customize the round disc pod surface by molding a customizable appearance or applying a decal or an advertising logo or a picture or a pin by the manufacturer or the user.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The field of endeavor is related to a simple, safe, and convenient dash mounted holder for sunglasses or eyewear for the driver to utilize in an on road vehicle whether the vehicle is parked or in motion. This invention can also be used on the passenger side of the dash to retain sunglasses or eyewear for the passenger as well. For the driver side the holder is placed in a safe mounted position on the dash near but not in the driver's direct line of sight to the road ahead. This invention is targeted at addressing the Virginia Tech Transportation Institute findings of the Director, Thomas A. Dingus, regarding vehicle accident studies.

Mr. Dingus included these excerpts in his study. He notes among other distractions that “reaching for a moving or non-moving object and taking a long glance at some external object” contributes to “distractions that lead to accidents.”

Mr. Dingus also reports that “in 93% of all rear-end crashes, the driver looked away from the roadway at least once within 5 seconds of the onset of the conflict. “He concludes, “redirecting the driver's eyes on the forward roadway may be one way to decrease crash rates.”

The United States Department of Transportation also cites the Virginia Tech Transportation Institute Study for the National Highway Safety Administration with the statement that “80% of all car wrecks are directly related to distracted driving.”

Other existing eyewear holder products are primarily visor clip devices with moving parts that can be potentially very distractive to operate or are mounted in a place distant from the driver's direct line of sight to the road ahead. Non-visor mounted products require some potentially distractive manipulation by the driver to operate them or they are not dash mounted. Other prior art is that most drivers have their sunglasses or eyewear hanging on the rearview mirror or lying loose on the dash where it slides around resulting in “driver reaching and grabbing distractions” and possible eyewear damage from scratching, bending, breaking, or their eyewear is comingled with other objects on the console, in the console, or in a case, or in a purse, or in a case in a purse or in a shirt pocket or on their lap.

### BRIEF SUMMARY OF THE INVENTION

The object of the invention is to provide a simple, safe, convenient holder for sunglasses or eyewear near the driver's direct line of sight to the road ahead. This invention with its low profile height allows the vehicle owner to position the invention in a safe and convenient place on the vehicle dash to the immediate left or immediate right of the driver's direct line of sight to the road ahead and also in a low position on the dash where the holder is effectively below the hood line left peripheral and right peripheral view through the windshield.

The invention provides a positive solution to greatly reduce driver distraction to access sunglasses or eyewear by keeping the driver's eyes on the road ahead. It protects the sunglasses or eyewear from damage from sliding or from being comingled with other objects in, or around, or on the console. There is no driver manipulation in the use of this invention to cause distraction because it does not have moving parts to deal with and eyewear temples remain in the open position when mounted on the holder similar to the same position they are worn by the driver or user.

### BRIEF DESCRIPTION OF THE SEVERAL VIEWS OF THE DRAWING

FIG. 1 is a perspective view of the holder for sunglasses or eyewear in accordance with the present invention;

FIG. 2 is a right side view of the holder for sunglasses or eyewear in accordance with the present invention. Note: the left side view (not shown) would be the mirror image of the right side view;

FIG. 3 is a front view that the driver or passenger would see from the steering wheel of the holder for sunglasses or eyewear in accordance with the present invention;

FIG. 4 is top view of the holder for sunglasses or eyewear in accordance with the present invention; and,

FIG. 5 is a perspective view of the holder for sunglasses or eyewear in accordance with the present invention with sunglasses or eyewear resting on the holder's pedestal with the eyewear temples in the recommended extended or open position.

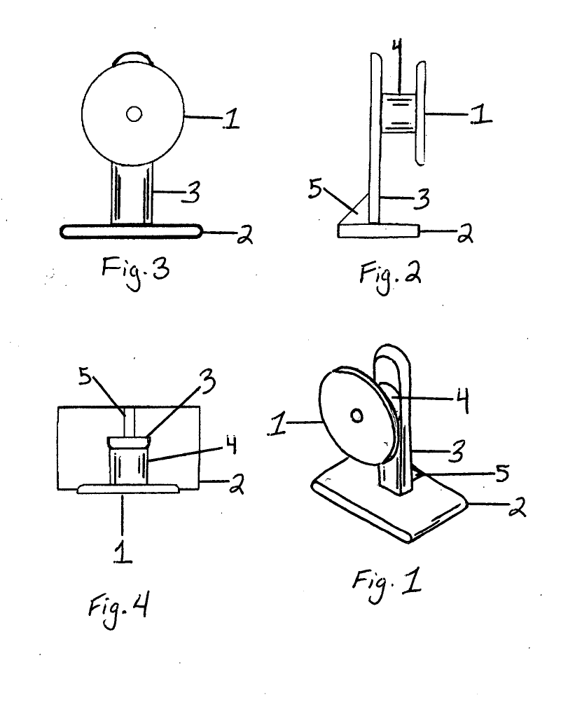

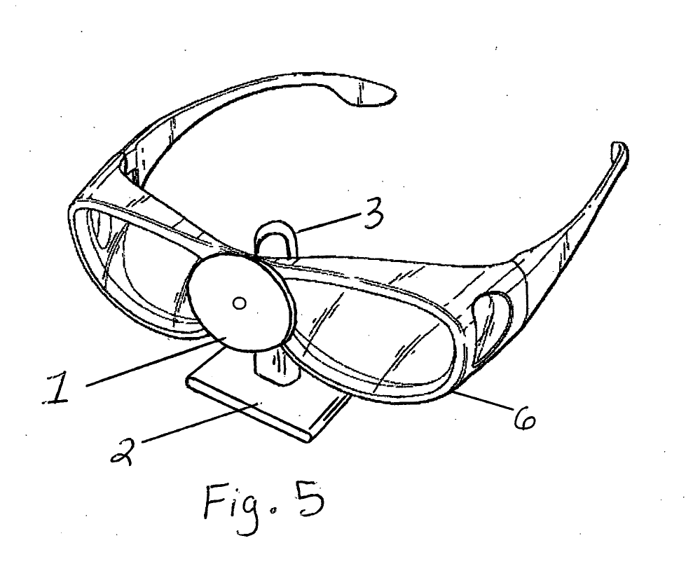

### DETAILED DESCRIPTION OF THE INVENTION

Referring to the aforementioned holder for sunglasses or eyewear and referencing FIG. 5 of the drawings showing sunglasses or eyewear, 6, mounted on the holder invention, the user receives the holder with double face tape already mounted on the rectangular bottom, 2, and is instructed to place sunglasses or eyewear, 6, on the pedestal, 4 (see FIG. 2), so the sunglasses or eyewear nose bridge is resting on pedestal, 4, and between the round disc pod surface, 1, and top of the post, 3. The post, 3, is supported by, 5, a molded in structural support brace. The top of the post, 5, provides the rear travel limit barrier for the sunglasses or eyewear nose bridge. The round disc pod surface, 1, provides the forward travel limit barrier for the sunglasses or eyewear nose bridge.

The user is instructed to move the invention around on the dash (while the eyewear is mounted) to an ideal location on the dash to the left or right of the direct sight line to the road ahead. The final location is also to be moved to a low enough height area to be below the hood line for left and right peripheral viewing of the road through the windshield. Once the ideal location is found the base, 2, can then be mounted to the dash using the double face adhesive tape.

Using the invention is simple to reduce driver distraction because eyewear is removed from the face with one hand and placed on the invention with the temples open or extended while eyes remain forward on the road ahead. Retrieving the glasses from the invention is the reverse process of lifting them off the invention and placing them on the user's face while the eyes remain forward on the road ahead.

Using the invention enhances safety because it is the best way to minimize driver distraction that results from visor mounted clips or other non-visor type holders that require driver manipulation to operate them. Use of the invention also provides safety for the eyewear by reducing possible damage from placing eyewear loose on the dash where they slide around on the dash or fall off the rearview mirror, or in the console or on the console comingled with other objects that can scratch them, or driver distraction from having them in a closed case, or in a purse, or in a case in a purse or other prior art locations. Maximum reduction of driver distraction while providing protection to the eyewear is an exclusive benefit of this invention.

Using the invention is convenient because it is simple to use and eyewear is always in eye sight straight ahead and handy for quick access which minimizes driver distraction. Maximum convenience is an exclusive benefit of this invention. The front of the invention includes a round disc pod surface with a hole in the middle. The hole is non-function and is a result of the injection mold process requirement. The manufacturer can mold in or the user can apply a decorative decal of their choice to cover the entire front of the round disc pod surface. This ability to customize the invention to advertise or place a desired design decal or advertising logo or a picture or a pin or a molded shape of any desire is an exclusive feature of this invention.

Manufacturing of the invention will be done with black ABS plastic to reduce UV light degradation compared to clear plastic. Colors other than black with appropriate plastic material can be used as well to ornamentally enhance the product. Plastic is favored because it is compliant with most material choices for on road vehicle non-frame members.

While the preferred embodiments of the invention have been described above, it will be recognized and understood that various modifications may be made therein and the potential future appended claims are intended to cover all such modifications which may fall within the spirit and scope of the invention

1. A holder applied to the dash of an on road vehicle to hold sunglasses or eyewear comprising:
a. an adhesive type mounting base with a means of an upright member to support a horizontal pedestal that holds said sunglasses or eyewear by the nose bridge of the said sunglasses or eyewear,
b. a said horizontal pedestal includes a means whereby to provide a barrier at both ends of the said pedestal to retain or limit the travel of the said sunglasses or eyewear nose bridge from sliding forward or backward on the said pedestal of the invention, and
c. using a surface on the vehicle operator's side of the invention for said sunglasses or eyewear to mold in or apply any advertising logos, any pictures, any decals, any pins, or a device to advertise said logos, said pictures, said decals or said pins.
